(19) United States
(12) Patent Application Publication
(10) Pub. No.: US 2026/0157905 A1
(43) Pub. Date: Jun. 11, 2026

(54) SYSTEMS, DEVICES, AND METHODS FOR CONTROLLING PATIENT SUPPORT DEVICES

(71) Applicant: Stryker Corporation, Portage, MI (US)

(72) Inventors: Arpeet JAIN, Gurgaon (IN); Marie-Lisa TAUCHMANN, Villingen-Schwenningen (DE); Bernd KUSKE, Spaichingen (DE); Seyit Kasim INAN, Volkertshausen (DE); Jakob SUM, Trossingen (DE)

(73) Assignee: Stryker Corporation, Portage, MI (US)

(21) Appl. No.: 19/410,417

(22) Filed: Dec. 5, 2025

Related U.S. Application Data
(60) Provisional application No. 63/729,017, filed on Dec. 6, 2024.

(51) Int. Cl. A61G 13/08

(52) U.S. Cl. CPC A61G 13/08; A61G 2203/12; A61G 2203/20; A61G 2203/44; A61G 2203/726

(57) ABSTRACT

A method for controlling a patient support device includes transmitting, by a controller of the patient support device, at least one information request via at least one communication bus to at least one patient support accessory that is modularly attached to a main portion of the patient support device, the at least one communication bus communicatively connecting the controller and at least one processor of the at least one patient support accessory; receiving, by the controller, at least one response from the at least one processor of the at least one patient support accessory via the at least one communication bus, the at least one response comprising information associated with the at least one patient support accessory; and controlling at least one function of the patient support device based on the information associated with the at least one patient support accessory.

### CROSS-REFERENCE TO RELATED APPLICATIONS

This application claims the benefit of U.S. Provisional Application No. 63/729,017, filed Dec. 6, 2024, the entire contents of which is incorporated herein by reference.

### FIELD

This disclosure relates generally to patient support devices, such as medical tables, and more specifically, to controlling articulation of patient support devices.

### BACKGROUND

Patient support devices, such as surgical tables, can be modular to customize the device for a specific use case or patient need. A patient support device can include a platform supported by a base that contacts a floor. One or more modular accessories may be attached to the platform for further supporting a patient in various ways depending on the specific use case or patient need. Such modular patient support devices are often articulatable. For example, the height of the platform may be adjusted and/or the platform and/or modular accessories may be tilted relative to the base and/or relative to one another. The range of articulation may be affected by which accessories are attached to the platform. For example, a tilt that is acceptable for a smaller accessory may cause a larger accessory to hit the floor, the base of the patient support device, or another obstacle.

Some patient support devices limit articulation of the platform based on whether a patient support accessory is attached to the platform. For example, a patient support device may utilize Hall sensors, resistance detectors, or RFID to detect when an accessory is attached to the table and limit articulation accordingly. However, while Hall sensors and resistance detectors can be used to determine that an accessory is attached, the patient support device is unable to differentiate between different types of accessories. RFID may provide information about the type of accessory attached but may be unable to determine which accessories are attached to the platform versus merely being nearby the platform and/or where the accessories are attached to the patient support device.

### SUMMARY

According to an aspect, systems, devices, and methods include a controller of a patient support device communicating with a processor of at least one patient support accessory modularly attached to a platform of the patient support device to obtain information associated with the at least one patient support accessory. The controller may use the information obtained from the patient support accessory to control at least one function of the patient support device that accounts for the patient support accessory. For example, the controller may set limits on a range of articulation of the patient support device to avoid collision of one or more modularly attached patient support accessories with the floor or other obstacles.

According to an aspect, a method for controlling a patient support device includes transmitting, by a controller of the patient support device, at least one information request via at least one communication bus to at least one patient support accessory that is modularly attached to a main portion of the patient support device, the at least one communication bus communicatively connecting the controller and at least one processor of the at least one patient support accessory; receiving, by the controller, at least one response from the at least one processor of the at least one patient support accessory via the at least one communication bus, the at least one response comprising information associated with the at least one patient support accessory; and controlling at least one function of the patient support device based on the information associated with the at least one patient support accessory.

The information associated with the at least one patient support accessory may include information associated with a weight capacity of the at least one patient support accessory. Controlling the at least one function may include displaying, on at least one display, a notification associated with the weight capacity of the at least one patient support accessory. The at least one display may include at least one display of the patient support device or at least one external display. The notification associated with the weight capacity may include a patient weight limit.

The information associated with the at least one patient support accessory may include dimensional information associated with a size of the at least one patient support accessory. The patient support device may be configured to articulate, and controlling the at least one function may include limiting articulation of the patient support device based on the dimensional information associated with the size of the at least one patient support accessory.

The information associated with the at least one patient support accessory may include identification information, and the method may include querying a database with the identification information to obtain at least one attribute of the at least one patient support accessory, wherein controlling the at least one function of the patient support device based on the information associated with the at least one patient support accessory may include controlling the at least one function of the patient support device based on the at least one attribute obtained from the database.

Receiving the at least one response from the at least one processor of the at least one patient support accessory may include receiving responses from multiple patient support accessories, and the method may include determining an arrangement of the multiple patient support accessories based on the responses. A response from a first patient support accessory of the multiple patient support accessories may be received via a first communication bus that is associated with a first side of the main portion of the patient support device and a response from a second patient support accessory of the multiple patient support accessories may be received via a second communication bus that is associated with a second side of the main portion of the patient support device, and wherein determining the arrangement of the multiple patient support accessories may include determining that the first patient support accessory is arranged at the first side of the main portion of the patient support device and the second patient support accessory is arranged at the second side of the main portion of the patient support device. A first patient support accessory of the multiple patient support accessories may be mounted to a second patient support accessory of the multiple patient support accessories, and wherein determining the arrangement of the multiple patient support accessories may include determining that the first patient support accessory is mounted to the second patient support accessory.

According to an aspect, a patient support device includes a main portion comprising a controller and a first communication bus portion; and a patient support accessory modularly attached to the main portion and comprising at least one processor, memory storing information associated with the patient support accessory, and a second communication bus portion that is connected to the first communication bus portion thereby forming a communication bus between the at least one processor and the controller, wherein the controller is configured to transmit at least one information request to the at least one processor of the patient support accessory via the communication bus to obtain the information associated with the patient support accessory and to control at least one function of the patient support device based on the information associated with the patient support accessory.

The first communication bus portion may include a first connector, the second communication bus portion may include a second connector, the patient support accessory may include mounts that engage with corresponding mounts of the main portion and the second connector may connect to the first connector when the mounts of the patient support accessory engage with the mounts of the main portion. The first communication bus portion may include a first connector that is connected to a connector of the patient support accessory and a second connector that is configured for connecting to a connector of an additional patient support accessory. The main portion may include a third communication bus portion for connecting to a communication bus portion of a second patient support accessory that is modularly attached to the main portion.

The communication bus between the at least one processor and the controller may include a single data transmission conductor. The communication bus may include an enable conductor that the controller uses to enable the at least one processor of the patient support accessory to communicate.

The information associated with the patient support accessory may include information associated with a weight capacity of the patient support accessory. Controlling the at least one function may include displaying, on at least one display of the patient support device and/or a display communicatively connected to the patient support device, a notification associated with the weight capacity of the patient support accessory. The notification associated with the weight capacity may include a patient weight limit.

The information associated with the patient support accessory may include dimensional information associated with a size of the patient support accessory. The patient support device may be configured to articulate, and controlling the at least one function may include limiting articulation of the patient support device based on the dimensional information associated with the size of the patient support accessory.

The information associated with the patient support accessory may include identification information, and the controller may be configured to query a database with the identification information to obtain at least one attribute of the patient support accessory, wherein controlling the at least one function of the patient support device based on the information associated with the patient support accessory may include controlling the at least one function of the patient support device based on the at least one attribute obtained from the database. The patient support accessory may be a first patient support accessory, and the patient support device may include a second patient support accessory modularly attached to the main portion or to the first patient support accessory, and the controller may be configured to determine an arrangement of the first and second patient support accessories based on the information obtained from the first patient support accessory and information obtained from the second patient support accessory.

According to an aspect, a non-transitory computer readable storage medium includes instruction for execution by one or more processors of a controller of a patient support device to cause the controller to perform any of the methods above.

It will be appreciated that any of the variations, aspects, features, and options described in view of the systems apply equally to the methods and vice versa. It will also be clear that any one or more of the above variations, aspects, features, and options can be combined.

### BRIEF DESCRIPTION OF THE DRAWINGS

The invention will now be described, by way of example only, with reference to the accompanying drawings, in which:

FIG. 1A is a diagram illustrating an exemplary patient support device for use in a medical procedure;

FIG. 1B illustrates an example of limiting the amount of articulation based on the configuration of the patient support accessories attached to the platform of the patient support device of FIG. 1A;

FIG. 2 illustrates a functional block diagram of an exemplary patient support device;

FIG. 3 illustrates an exemplary mounting arrangement that provides automatic connection of communication bus connectors;

FIG. 4 illustrates an exemplary patient support device that uses a two-conductor communication bus for communicatively connecting multiple patient support accessories to a controller of the patient support device;

FIG. 5 shows a schematic diagram of an exemplary patient support device having a communication bus that is configured for enabling a controller of the patient support device to determine the arrangement of the patient accessories;

FIGS. 6A-6B show a schematic diagram of an exemplary patient support device having one or more patient support accessories mounted to side rails;

FIG. 7 shows an exemplary method for controlling a patient support device; and

FIG. 8 shows a block diagram of an exemplary computing system.

### DETAILED DESCRIPTION

In the following description of the various examples, reference is made to the accompanying drawings in which are shown, by way of illustration, specific examples that can be practiced. The description is presented to enable one of ordinary skill in the art to make and use the invention and is provided in the context of a patent application and its requirements. Various modifications to the described examples will be readily apparent to those persons skilled in the art, and the generic principles herein may be applied to other examples. Thus, the present invention is not intended to be limited to the examples shown but is to be accorded the widest scope consistent with the principles and features described herein.

According to an aspect, systems, devices, and methods described herein can include controlling at least one function of a patient support device based on a configuration of at least one patient support accessory modularly attached to the patient support device. A controller of the patient support device can obtain information associated with an attached patient support accessory via a communication bus established between a processor of the patient support accessory and a controller of the patient support device. The communication bus between the controller and patient support accessory can extend to one or more additional patient support accessories modularly attached to the patient support accessory, enabling the controller to obtain information associated with the additional patient support accessories. Based on the information obtained from any attached patient support accessories, the controller can control at least one function of the patient support device in a manner that takes into account the configuration of the attached patient support accessories. For example, the controller can use information obtained from any attached patient support accessories to control articulation of the platform to prevent collisions (e.g., to avoid collision with the floor and/or with a base of the patient support device itself). Additionally, or alternatively, the information associated with the attached patient support accessories can be used to notify a user of a weight capacity of the patient support device that accounts for the attached patient support accessories, thereby improving patient safety.

A communication bus connecting the controller of the patient support device with one or more attached patient support accessories includes electrical connections between one or more attached patient support accessories and the controller. This arrangement may be advantageous relative to, for example, wireless communication between a controller and patient support accessory in being a more reliable communication connection and/or in avoiding incorrectly determining that a nearby patient support accessory that is not attached to the patient support device as being attached to the patient support device. The communication bus arrangement according to the principles described herein may be advantageous relative to simple make/break connections in that information specific to a given patient support accessory can be communicated to the controller such that the configuration of a given patient support accessory does not have to be assumed by the controller.

In the following description, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes,” “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating,” or the like refer to the action and processes of a computer system, or similar electronic computing device, that manipulates and transforms data represented as physical (electronic) quantities within the computer system memories or registers or other such information storage, transmission, or display devices.

The present disclosure, according to an aspect, also relates to devices or systems for performing the operations herein. The devices or systems may be specially constructed for the required purposes, may comprise a general-purpose computer selectively activated or reconfigured by a computer program stored in the computer, or may include any combination thereof. Computer instructions for performing the operations herein can be stored in any combination of non-transitory, computer-readable storage medium, such as, but not limited to, any type of disk, including USB flash drives, external hard drives, optical disks, CD-ROMs, magnetic-optical disks, read-only memories (ROMs), random access memories (RAMs), EPROMs, EEPROMs, magnetic or optical cards, or any type of media suitable for storing electronic instructions, and each coupled to a computer system bus. One or more instructions for performing the operations herein may be implemented in or executed by one or more Application Specific Integrated Circuits (ASICs), Field Programmable Gate Arrays (FPGAs), Digital Signal Processing units (DSPs), Graphics Processing Units (GPUs), Central Processing Units (CPUs), or any other suitable processing unit. Furthermore, the computers referred to herein may include a single processor or may be architectures employing multiple processor designs for increased computing capability.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention as described herein.

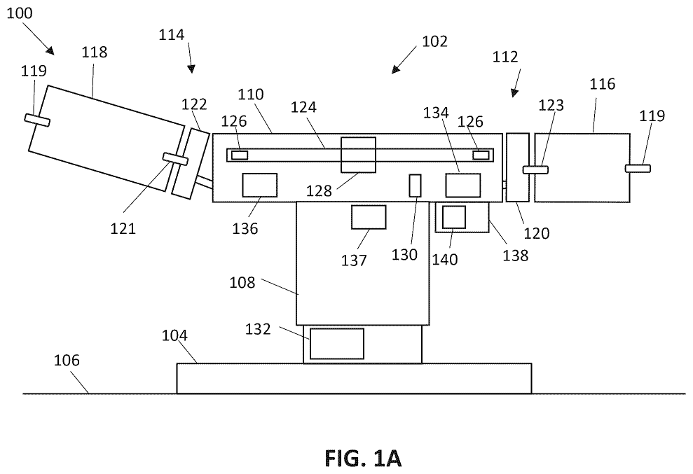

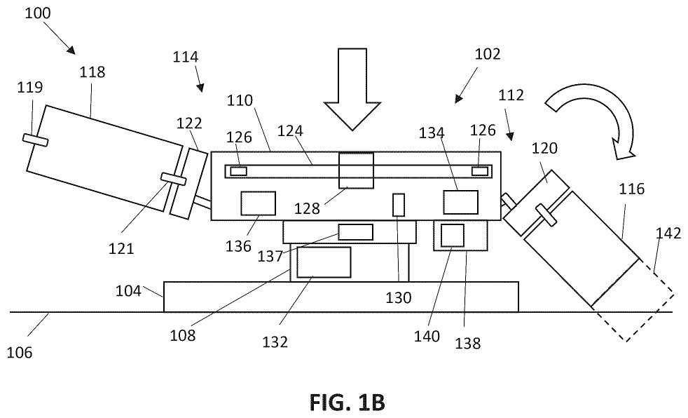

FIG. 1A is a diagram illustrating an exemplary patient support device 100 for use in a medical procedure, such as a surgical procedure or an imaging or other diagnostic procedure. The patient support device 100 can include a main portion 102 that includes a base 104 for contacting the floor 106 of the medical room, a pedestal 108 rising from the base 104, and a platform 110 supported by the pedestal 108 and configured for supporting a patient. The patient support device can be, for example, a surgical table, an examination table, an imaging or other diagnostic table, a transport bed or table, or any other type of device on which a patient may be positioned.

The patient support device 100 can include one or more modularly attachable patient support accessories 116, 118 that may be selectively attached to the platform 110 and/or to each other for further supporting the patient. For example, patient support accessory 116 may be attached at a first end 112 of the platform 110 and may be configured for supporting a patient's legs, and patient support accessory 118 may be attached at a second end 114 of the platform 110 and configured for supporting a patient's head. As used herein, modularly attachable patient support accessory means that the patient support accessory (e.g., patient support accessories 116, 118) may be attached to the platform 110 and/or to each other in various configurations. For example, patient support accessory 116 can be attached at the second end 114 of the platform 110 instead of patient support accessory 118 or may be attached to patient support accessory 118.

The platform 110 may include one or more end portions 120, 122 that may be tiltable relative to the rest of the platform 110. The patient support accessories 116, 118 may be attachable to the end portions 120, 122, such as via one or more mounts 121, 123, which may have standardized configurations such that either patient support accessory 116 or patient support accessory 118 (or any other patient support accessory) can be attached to either end portion 120, 122. The patient support device 100 may include one or more side rails 124 extending along the sides of platform 110 and mounted to the platform 110 by one or more side rail mounts 126. One or more patient support accessories 128 may be attached to the side rails 124. The accessories (e.g., patient support accessories 116, 118, 128) may include, but are not limited to, table extenders (e.g., for imaging), leg holders (e.g., long split leg holders, short split leg holders), head plates (e.g., dual articulation head section plates), back plates (e.g., split back plates), pediatric tables, transurethral (TUR) plates, adjustable leg transfer boards, and shoulder chairs. Optionally, one or more of the patient support accessories 116, 118 may include mounts 119 for mounting an additional patient support accessory such that patient support accessories can be linked in a daisy-chain manner.

The patient support device 100 may be configured to articulate in various ways. For example, pedestal 108 can be telescopic and may include one or more actuators 132 for adjusting the height of the platform 110. The platform 110 may be tiltable in one or more directions. For example, the platform 110 may be tiltable about an axis extending left-to-right in FIG. 1A, which may be useful for tilting a patient sideways, and/or about an axis extending into page in FIG. 1A, which may be useful for tilting a patient head up or head down. The patient support device 100 may include one or more actuators 137 for tilting the platform 110 about one or more axes. The patient support device 100 may be configured to independently tilt the end portions 120, 122, such as for articulating patient support accessories 116, 118 relative to the platform 110. The patient support device 100 may include an actuator 136 for tilting end portion 122 and/or an actuator 134 for tilting end portion 120. The platform 110 may be translatable in one or more lateral directions. For example, the platform 110 may be translatable in a direction along the length of the platform 110 (the left-to-right direction in FIG. 1A) and/or in a direction along the width of the platform 110 (into and out of the page in FIG. 1A).

The patient support device 100 can include a controller 130 for controlling various actuators (e.g., actuators 132, 134, 136, and 137) for articulating the patient support device 100. The controller 130 may be communicatively coupled to one or more motors, valves, or other electronically controllable components of the various actuators (e.g., actuators 132, 134, 136, and 137) for articulating the patient support device 100. For example, the controller 130 may be coupled to a motor of actuator 132 for adjusting the height of the platform 110, a motor of actuator 134 for tilting the end portion 120, a motor of actuator 136 for tilting the end portion 122, and/or a motor of actuator 137 for tilting the platform 110.

The patient support device 100 can include a user input device 138 for receiving user inputs for articulating the patient support device 100. For example, the user input device 138 may receive user inputs (e.g., via a touch screen, a keyboard, a keypad, button(s), microphone, etc.) for adjusting the height of, tilting, or otherwise articulating the platform 110. The user input device 138 may be communicatively coupled (e.g., via a wired or wireless connection) to the controller 130 for controlling the patient support device 100 based on the instructions.

The user input device 138 may be a handheld device that is removably attachable and/or physically detached from the remainder of the patient support device 100. The user input device 138 may be integrated into the main portion 102, such as into the platform 110 or into the pedestal 108. The user input device 138 can include a display 140 for displaying information relevant to the patient support device 100. For example, the display 140 may display one or more aspect of the position (e.g., the height of one or more tilt angles, etc.) of the platform 110. In some examples, as described in greater detail below, the display 140 can display the weight capacity of the patient support device 100.

The patient support device 100 can be articulated to position a patient as desired for a particular procedure. Articulation can include, but is not limited to, adjusting the height of the platform 110, tilting the platform 110 in one or more directions, laterally translating the platform 110 in one or more directions, and/or pivoting only a portion of the platform 110 (e.g., the end portions 120, 122). Multiple of these various articulations and/or any other articulations can occur sequentially or simultaneously. The patient support device 100 may be configured to limit the degree to which it can be articulated based on the accessories attached to the platform 110.

FIG. 1B illustrates an example of limiting the amount of articulation of the patient support device based on the configuration of the patient support accessories attached to the platform. The amount of pivoting of the end portion 120 and the amount of adjusting the height of the platform 110 allowed by the controller 130 may be limited based on the configuration of the patient support accessory attached to the end portion 120. In the illustrated example, the end portion 120 is tilted downward and the platform 110 is in a lowered position. The controller 130 may be configured to limit further lowering of the platform 110 and/or further tilting of the end portion 120 such that the patient support accessory 116 does not hit the floor 106. The controller 130 may be configured to determine how to limit articulation in a manner that accounts for the configuration of the patient support accessories that are attached. To do this, the controller 130 may retrieve information regarding the patient support accessory 116 from the patient support accessory 116 and use this information to limit articulation of the patient support device 100 so that articulation of the patient support device 100 in its specific configuration with the attached patient support accessories does not cause collisions. For example, the controller 130 may limit articulation of the patient support device 100 such that the patient support accessory 116 does not collide with the floor 106, the base 104, and/or another part of the patient support device 100. By retrieving information from the patient support accessory 116, the controller can set limits to articulation that are specific to the configuration of the patient support accessory or accessories that are attached, enabling the articulation to be limited based on the types of accessories that are attached and the locations where they are attached. Thus, in the example of FIG. 1B, a limit for the amount that the platform 110 can be lowered and/or a limit for the amount that the end portion 120 may be tilted may be different when the larger patient support accessory 142 is attached to the platform 110 than when the smaller patient support accessory 116 is attached to the platform.

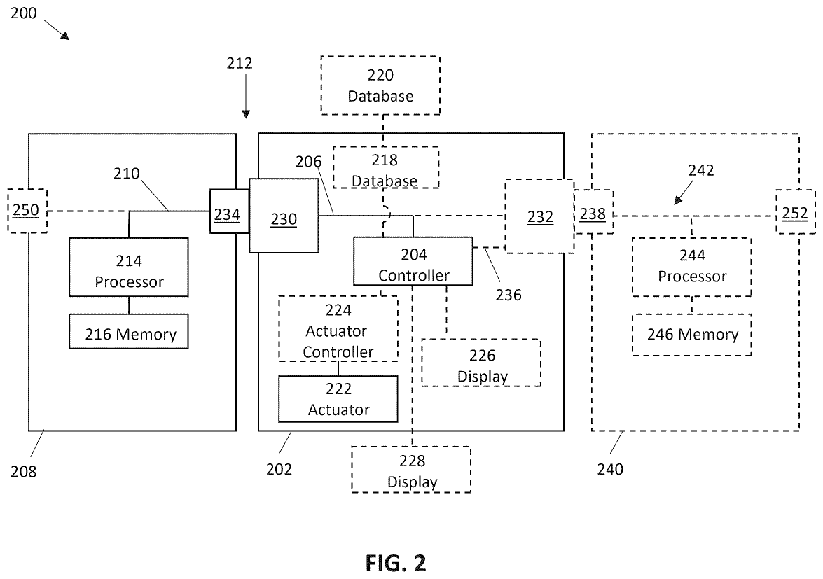

FIG. 2 illustrates a functional block diagram of a patient support device 200 having a main portion 202 and a modularly attached patient support accessory 208. The patient support device 200 may be representative of the patient support device 100 illustrated in FIGS. 1A-1B. For example, features described with respect to main portion 202 can be embodied by main portion 102.

The main portion 202 can include at least one controller 204. The at least one controller 204 can include one or more processors and memory storing one or more programs for execution by the one or more processors for causing the controller to perform any of the functions described herein. The controller 204 may include a single processor or multiple processors. The controller 204 may be implemented in a single component (e.g., a microcontroller) or multiple components. The functionality described herein with respect to a controller can be implemented in any combination of hardware and software. The controller 204 may be electrically connected to a first communication bus portion 206.

The patient support accessory 208 may include at least one processor 214 and a second communication bus portion 210. The second communication bus portion 210 electrically couples to the first communication bus portion 206 when the patient support accessory 208 is attached to the main portion 202, forming a communication bus 212 that communicatively connects the processor 214 and the controller 204. For example, the first communication bus portion 206 may include a connector 230, and the second communication bus portion 210 of the patient support accessory 208 may include a connector 234 that connects to connector 230 when the patient support accessory is attached to the main portion 202. The patient support accessory 208 can include memory 216 storing information associated with the patient support accessory 208 that can be accessed by the processor 214. The processor 214 and the memory 216 may be embodied in the same or different electronic chips.

The controller 204 may query the processor 214 of the patient support accessory 208 via the communication bus 212 to obtain the information associated with the patient support accessory 208 stored in the memory 216. The processor 214 may respond to the query by retrieving the information from the memory and transmitting the information to the controller 204 via the communication bus 212. The controller 204 may use the information to control one or more functions of the patient support device 200, such as to control one or more ranges of articulation of the patient support device.

The information associated with the patient support accessory 208 that is obtained by the controller 204 may include at least one attribute of the patient support accessory 208. The at least one attribute may include at least a one-dimensional attribute associated with the size of the patient support accessory 208, such as length, width, and/or height of the patient support accessory 208. An attribute of the patient support accessory 208 may include information associated with use of the patient support capacity, such as a weight capacity of the patient support accessory 208. An attribute of the patient support accessory 208 may include information associated with the origin of the patient support accessory 208, such as a model number, a manufacturer, and/or a production date of the patient support accessory 208.

The information associated with the patient support accessory 208 that is obtained from the patient support accessory 208 by the controller 204 may include identification information associated with the patient support accessory 208. The identification information can include, for example, a model name or number and/or a number unique to the specific patient support accessory 208, such as a unique identifier (ID) or serial number for the patient support accessory 208. The identification information associated with the patient support accessory 208 may be used by the controller 204 to obtain one or more attributes (e.g., any of the attributes described above) from a local database 218 of the patient support device 200 that is communicatively connected to the controller 204. For example, attributes of different patient support accessories may have been stored in the local database 218 in association with identification information for the different patient support accessories, and the controller may query the database 218 with the identification information for the patient support accessory 208 to obtain at least one attribute associated with the patient support accessory 208. Alternatively, the controller 204 may query a remote database 220 with the identification information for the patient support accessory 208 to obtain at least one attribute associated with the patient support accessory 208. The controller 204 may access the remote database 220 via any suitable connection to a remote computing system (e.g., a direct connection to a remote computing system or a connection via one or more networks).

As noted above, the controller 204 may limit articulation of the patient support device 200 based on dimensional information associated with the size of the patient support accessory 208. The controller 204 may control one or more actuators 222 to articulate the patient support device 200 within limits that account for the dimensional information. The controller 204 may control the one or more actuators 222 directly or through one or more actuator controllers 224 communicatively coupled to the controller 204. The controller 204 may obtain the information associated with the patient support accessory 208 and may determine limits to the articulation of patient support device 200 that accounts for the patient support accessory 208. For example, the controller 204 may determine an overall length of the patient support device 200 with the patient support accessory 208 attached and may determine a limit of tilt of the patient support device 200 given the overall length such that the patient support accessory does not collide with the floor. The controller 204 may receive a user input to tilt the patient support device 200 in the length direction by a maximum amount and, in response, may control an actuator 222 that tilts the patient support device 200 until the determined limit of tilt is reached.

The information associated with the patient support accessory 208 that is obtained by the controller 204 may be used by the controller 204 to display one or more notifications to a user. For example, the controller 204 may be configured to display a notification on at least one display 226 of the patient support device 200 and/or on at least one external display 228 that is communicatively connected to the controller 204. The external display(s) 228 may be a display directly connected to the patient support device 200 (e.g., a display located in the same room as the patient support device 200 that is connected to the patient support device 200 via an HDMI cable or other type of video cable) and/or a display that is connected to the patient support device via one or more networks (e.g., a remote display, a display located in the same room as the patient support device 200 but communicatively connected via a network, etc.). The controller 204 may be configured to display a notification associated with the weight capacity of the patient support accessory 208, such as a patient weight limit. The controller 204 may obtain the information associated with the weight capacity of the patient support accessory 208 from the patient support accessory (i.e., the information received by the main controller from the patient support accessory 208 may include the weight capacity) or from the local database 218 or the remote database 220. Where the patient support device 200 includes multiple attached patient support accessories that have different weight limits, the controller 204 may determine the lowest weight limit and display a notification associated with the lowest weight limit.

The controller 204 may be configured to display a notification associated with the lifespan of the patient support accessory 208. For example, the patient support device 200 may display a notification when the patient support accessory 208 is nearing an end of its lifespan to ensure safe use of the accessory. The lifespan of the patient support accessory 208 may be included in the information obtained by the controller 204 from the patient support accessory 208 or may be obtained by the controller 204 from the local database 218 or the remote database 220.

The main portion 202 of the patient support device 200 may be configured for a second patient support accessory 240 to be attached to the main portion 202 at a different location from the patient support accessory 208 (e.g., at an opposite side of the main portion 202). Like patient support accessory 208, patient support accessory 240 may include at least one processor 244 and memory 246 storing information associated with the patient support accessory 240. Controller 204 may communicate with processor 244 for obtaining information associated with the patient support accessory 240 that is stored in memory 246 in similar fashion to the communication between controller 204 and processor 214 of patient support accessory 208. Patient support accessory 240 may include a second communication bus portion 242 that connects to the processor 244 and includes a connector 238 that connects to a corresponding connector 232 of the main portion 202 when the patient support accessory 240 is attached to the main portion 202. The connector 232 may electrically connect to the first communication bus portion 206 of the main portion 202 such that patient support accessory 240 is connected to the same communication bus as patient support accessory 208. Alternatively, the main portion 202 may include a second communication bus portion 236 that includes the connector 232 such that the controller 204 communicates with the processor 244 of patient support accessory 240 on a different communication bus (formed by communication bus portion 242 and communication bus portion 236) than the communication bus on which the controller 204 communicates with the processor 214 of patient support accessory 208 (communication bus 212). By using different buses for communicating with the accessories mounted at different locations, the controller 204 can determine which patient support accessory is connected to which location of the main portion 202.

Patient support accessory 208 may include a connector 250 for electrically connecting to an additional patient support accessory (not shown) that is attached to patient support accessory 208, extending the communication bus 212 to the additional patient support accessory. Similarly, patient support accessory 240 may include connector 252 for communicatively connecting a processor of an additional patient support accessory that is attached to patient support accessory 240 to the controller 204. Extending the communication bus to additional patient support accessories enables the controller 204 to communicate with each of the additional patient support accessories to obtain information from those additional patient support accessories for use in controlling at least one function of the patient support device 200 in a manner that accounts for each of the attached patient support accessories. For example, the controller 204 may determine the total length of multiple attached patient support accessories by summing the lengths of each patient support accessory (which is obtained via the information that the controller 204 receives from the processor of each patient support accessory). The controller 204 may use this total length to determine a tilt limit such that the patient support accessory at the end of a chain of patient support accessories does not collide with a floor.

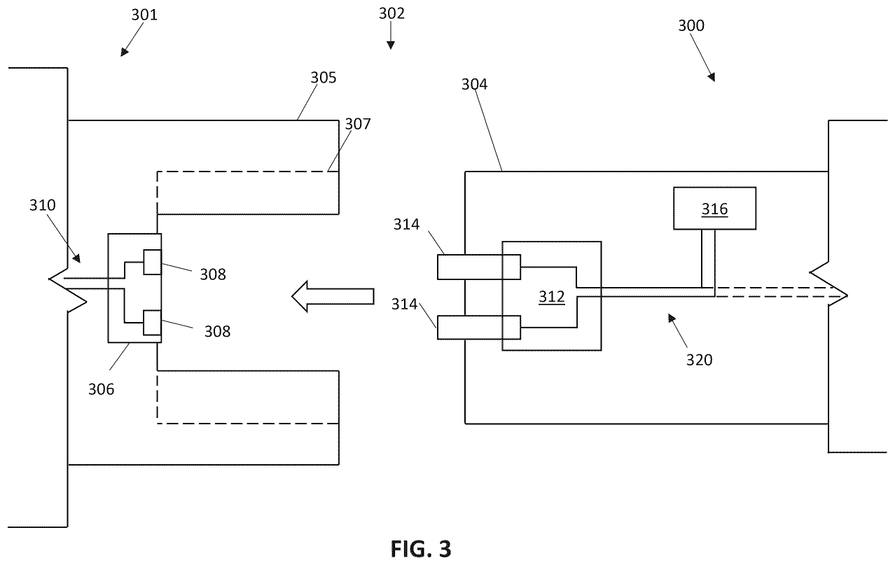

A patient support accessory and the main portion of a patient support device may be configured to attach to one another such that their communication bus connectors, such as connectors 230 and 234 of FIG. 2, automatically connect upon attachment of the patient support accessory to the main portion and/or to another patient support accessory. An example mounting arrangement that provides automatic connection of communication bus connectors is illustrated schematically in FIG. 3. The illustrated example is a side view showing a first component 300 being attached to a second component 301. The first component 300 may be a patient support accessory, such as patient support accessory 116 of FIG. 1, and the second component 301 may be a platform of the patient support device, such as platform 110 of FIG. 1, or the first component 300 may be a first patient support accessory and the second component may be a second patient support accessory.

The first component 300 is attachable to the second component 301 via a mount 302. The mount 302 includes a first mounting portion 304 of component 300 that engages with a corresponding second mounting portion 305 of the second component 301. The mount 302 may have any suitable configuration. For example, the first mounting portion 304 may be a rail that slides into a slot 307 of the second mounting portion 305. A second mount may be provided on an opposite side of the first and second components 300, 301 (not shown). The mount 302 may be used for mount 121 and/or mount 123 of patient support device 100 of FIG. 1A.

A first connector 312 may be attached or otherwise integrated into first mounting portion 304. First connector 312 may be used, for example, for connector 234 of FIG. 2. A second connector 306 may be attached or otherwise integrated into second mounting portion 305. Second connector 306 may be used, for example, for connector 230 of FIG. 2. First connector 312 may include a set of spring-loaded pins 314, second connector 306 may include a corresponding set of contact pads 308. Upon insertion of the first mounting portion 304 into the second mounting portion 305, the set of spring-loaded pins 314 automatically engage the set of contact pads 308. Other examples of connectors that may be used include, but are not limited to, pin and socket connectors, blade connectors, cylindrical connectors, magnetic connectors, etc.

The spring-loaded pins 314 are connected to electrical conductors (e.g., a ground conductor and a signal conductor) forming a bus portion 320 of the first component 300. A processor 316 of the first component may be electrically connected to the bus portion 320. The bus portion 320 may extend to a connector at another location of the first component 300 (e.g., a connector at the other end of a patient support accessory to which another patient support accessory may be connected). Similarly, the set of contact pads 308 are connected to electrical conductors (e.g., a ground conductor and a signal conductor) forming a bus portion 310 of the second component 301. The bus portion 310 may extend to a processor (e.g., controller 204 of FIG. 2) and/or to a connector at another location of the second component 301. Thus, when the spring-loaded pins 314 and contact pads 308 are connected, a communication bus is formed connecting the processor 316 of the first component 300 with a processor of the second component 301.

The number of spring-loaded pins 314 and contact pads 308 may be different in different arrangements depending on the number of electrical conductors of the communication bus. In some examples, the communication bus includes only two conductors—a ground conductor and a signal conductor. In other examples, the communication bus may include three conductors—a ground conductor and two signal conductors. In general, any communication bus configuration having any number of conductors can be used.

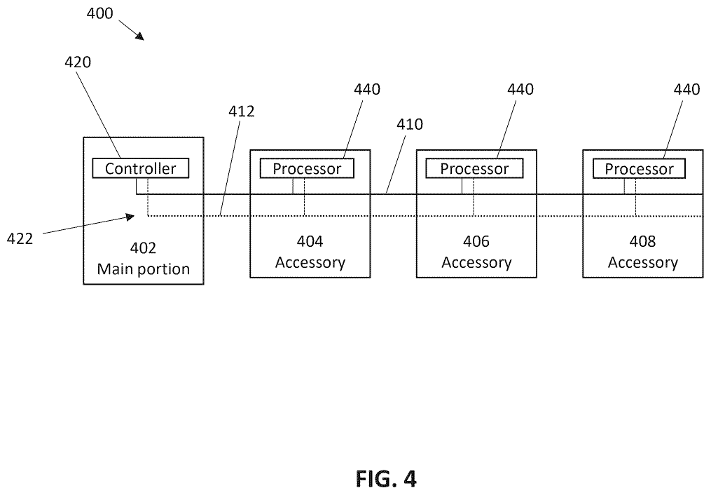

FIG. 4 illustrates an exemplary patient support device 400 that uses a two-conductor communication bus 422 for communicatively connecting multiple patient support accessories 404, 406, 408 to a controller 420 of the patient support device 400. The communication bus 422 can be used, for example, for communication bus 212 and/or communication bus portion 242 of patient support device 200 of FIG. 2. In the illustrated example, patient support accessory 404 is attached to the main portion 402, patient support accessory 406 is attached to patient support accessory 404, and patient support accessory 408 is attached to patient support accessory 406. Controller 420 is communicatively connected to the processor 440 of each of the patient support accessories 404, 406, 408 via the two-conductor communication bus 422. The two-conductor communication bus 422 includes a ground conductor 412 and a single signal conductor 410. The ground conductor 412 and single signal conductor 410 may provide power to the processor 440 of each of the patient support accessories 404, 406, 408. For example, a 5V DC voltage may be provided via the ground conductor 412 and single signal conductor 410 for at least some period of time. The processor 440 of each of the patient support accessories 404, 406, 408 may include one or more components for power storage (e.g., one or more capacitors) so that the processors 440 have available power when the ground conductor 412 and single signal conductor 410 are used for communication. Using a two-conductor configuration for the communication bus 422 may be beneficial in providing a simple, low-cost, and robust way to communicatively connect the controller 420 to the processors 440 of the patient support accessories 404, 406, 408. The controller 420 and processor of each of the patient support accessories 404, 406, 408 may communicate using, for example, a serial, half-duplex bidirectional communication protocol, such as the 1-WIRE communication protocol.

In some aspects, the communication process carried over the two-conductor communication bus 422 may utilize a full power line communication (PLC) process, which permits the same conductor(s) that supply power to the patient support accessories 404, 406, 408 (e.g., processors 440, control electronics, sensors, motors, etc., thereof) to also serve as a bidirectional communication medium. Data signals may be superimposed on the electrical power transmitted through the single signal conductor 410 and the ground conductor 412. The PLC process may enable both data and power to be conveyed concurrently over the same conductors by modulating a high-frequency data signal onto the power signal present on the single signal conductor 410. One or more of the communication modules (e.g., controller 420 and/or processors 440) may include a modulation and demodulation unit configured to inject modulated data signals onto the single signal conductor 410 and to extract data signals therefrom. The modulation and demodulation units may be electrically coupled to the conductors through a capacitor that allow the high-frequency communication signals to pass while blocking direct current (DC) components. In some aspects, the communication interface may be compatible with standardized bus protocols, such as Controller Area Network (CAN) or Ethernet, with the PLC process providing the physical transmission layer.

The two-conductor communication bus 422 may operate in a configuration in which the available power on the communication line is limited. The two-conductor communication bus 422 may primarily function as a communication bus, with the electrical power transmitted thereon being restricted to a level sufficient to operate one or more powered components (the processors 440, control electronics, sensors, etc.) of the connected patient support accessories 404, 406, 408. The amount of power deliverable in this configuration may depend on the electrical characteristics of the communication wire and the design of the associated modulation and demodulation circuitry. One or more of the controller 420 and/or processors 440 may include modulation and demodulation units configured to transmit and receive communication signals over the single signal conductor 410 while also providing a limited power supply to the accessory electronics. Thus, in this configuration, the communication and power signals may coexist on the same conductors, but the current capacity and voltage level may be constrained so as not to exceed the limits of the communication wiring.

The controller 420 can initiate and control communication with the processors of the patient support accessories 404, 406, 408 to obtain information stored in each patient support accessory 404, 406, 408 (e.g., in a memory of each patient support accessory). The controller 420 may periodically transmit a discovery request via the communication bus 422 to determine which patient accessories are connected. A processor of an attached patient support accessory may respond to the discovery request with an identifier. The controller 420 may use an identifier to request from the associated processor the information associated with the patient support accessory that the controller 420 may use to control at least one function of the patient support device 400. For example, controller 420 may send at least one discovery request via communication bus 422. The processor of patient support accessory 404 may respond to the discovery request with an identifier that is unique to the processor. Similarly, the processors of patient support accessories 406 and 408 may respond to the discovery request with their unique identifiers. The controller 420 may query the processor of patient support accessory 404 using its identifier to obtain information associated with the patient support accessory 404, such as identifying information, dimensions, a weight capacity, or any other information stored by patient support accessory 404. The processor of patient support accessory 404 may respond to the query with the requested information. The controller 420 may obtain information from patient support accessory 406 and patient support accessory 408 in similar fashion.

Optionally, the controller 420 may be configured to determine the arrangement of the patient support accessories 404, 406, 408 based on a sequence by which the controller 420 receives the identifier of the processors of the patient support accessories 404, 406, 408. For example, controller 420 may determine that patient support accessory 404 is attached to the main portion 402 based on the processor of patient support accessory 404 being the only one to respond to the discovery request sent by the controller 420 (because the other patient support accessories 406, 408 have not yet been attached). Controller 420 may determine that patient support accessory 406 is attached to patient support accessory 404 based on the controller 420 receiving identifiers from the processors of patient support accessory 404 and 406 (but not patient support accessory 408 because it is not yet attached) and knowing that patient support accessory 404 is attached to main portion 402.

As noted above with respect to patient support device 200 of FIG. 2, the main portion 202 may include connectors on multiple sides of the main portion 202 for attachment of multiple patient support accessories to the main portion 202. As such, the communication bus arrangement of FIG. 4 can be replicated for any number of attachment locations of the main portion 202. For example, a second daisy chain arrangement of patient support accessories analogous to those shown in FIG. 4 can be accommodated on an opposite side of the main portion 402 and may include a communication bus that is communicatively isolated from communication bus 422, thereby enabling the controller 420 to determine on which side of the main portion a given patient support accessory is located.

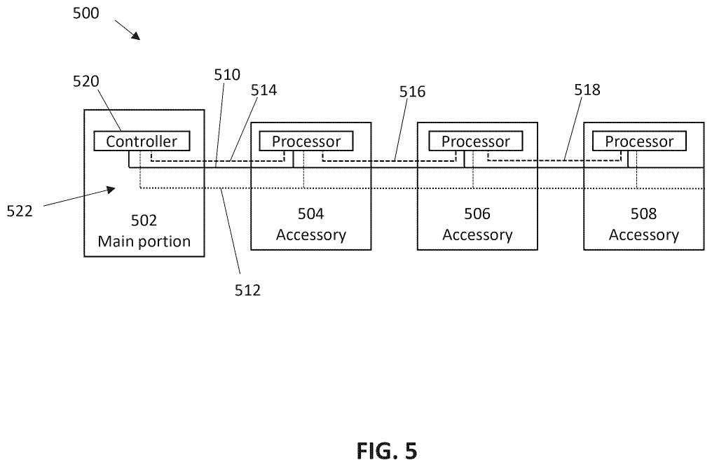

FIG. 5 shows a schematic diagram of an exemplary patient support device 500 having a communication bus 522 that is configured for enabling a controller 520 of the patient support device 500 to determine the arrangement of the patient support accessories 504, 506, 508 while all of the patient support accessories 504, 506, 508 are attached to the main portion 502. The communication bus 522 can be used, for example, for communication bus 212 and/or communication bus portion 242 of patient support device 200 of FIG. 2. The communication bus 522 can include a signal conductor 510 and a ground conductor 512, each of which connects to the processor of each patient support accessory 504, 506, 508. Unlike the arrangement of FIG. 4, an “enable” conductor can connect processors of adjacent devices. Enable conductor 514 connects an output of the controller 520 to an input of the processor of patient support accessory 504, enable conductor 516 connects an output of the processor of patient support accessory 504 to an input of the processor of patient support accessory 506, and enable conductor 518 connects an output of the processor of patient support accessory 506 to an input of the processor of patient support accessory 508.

The enable conductors 514, 516, 518 can be used to control whether a given processor responds to messages sent via the signal conductor 510. A process for determining the arrangement of the patient support accessories 504, 506, 508 may include the controller 520 setting the enable conductor 514 to an “on” state. This enables the processor of patient support accessory 504 to transmit information to the controller 520 via the signal conductor 510. At this time, enable conductors 516 and 518 may be in the “done” state, which places patient support accessories 506, 508 in a listening mode in which they do not respond to messages transmitted on the signal conductor 510. This enables the controller 520 to know that the information it is receiving is only from patient support accessory 504. Once the information from patient support accessory 504 is received, the controller 520 can set the enable conductor 514 to a “done” state, which may cause the processor of the patient support accessory 504 to set enable conductor 516 to the “on” state and to switch into a listening mode. With the enable conductor 516 in the “on” state, the processor of patient support accessory 506 can communicate via the signal conductor 510 to provide information associated with patient support accessory 506 to controller 520. At this point, both patient support accessory 504 and patient support accessory 508 are in listening modes. This enables the controller 520 to determine that the information it is receiving (the information from patient support accessory 506) is coming from the second patient support accessory in the chain. This process can continue until all of the patient support accessories have provided their information to the controller 520. By utilizing the enable conductors 514, 516, 518 to control the sequence of responses from the patient support accessories 504, 506, 508 according to their sequential location, the controller 520 may determine the relative positions of the patient support accessories 504, 506, 508 based on the order in which the controller 520 receives responses from the patient support accessories 504, 506, 508.

The communication bus configurations and communication processes are intended merely as examples. Any suitable communication bus configuration and communication protocol can be used. For example, alternative communication protocols include, but are not limited to, serial peripheral interface (SPI), inter-integrated circuit (I2C), and/or CAN bus.

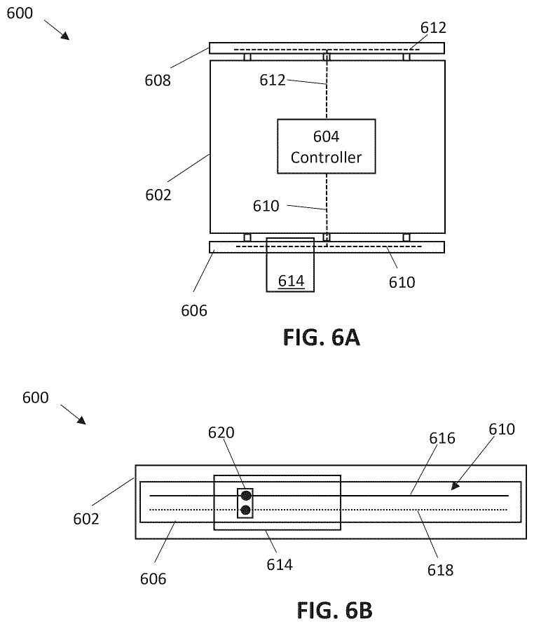

As noted above, patient support accessories may be modularly attached to one or more side rails of the platform of the patient support device. FIGS. 6A-6B show a schematic diagram of an exemplary patient support device 600 having side rails 606, 608 mounted to a main portion 602 (e.g., a platform of the main portion) and a patient support accessory 614 attached to side rail 606. FIG. 6A depicts a top view of the patient support device 600, and FIG. 6B depicts a side view of the patient support device 600. The patient support device 600 can be exemplary of the patient support device 100 of FIGS. 1A-1B and patient support device 200 of FIG. 2. As such, the features described below can be implemented in patient support device 100 and/or patient support device 200.

The patient support device 600 can include a communication bus 610 extending between the controller 604 and a side rail 606, and a communication bus 612 extending between the controller 604 and the side rail 608. Each communication bus 610, 612 can include, for example, a single signal conductor 616 and a ground conductor 618 in similar fashion to communication bus 422 of FIG. 4. However, this is merely exemplary, and it should be understood that any communication bus configuration can be used as required for a given communication protocol. Communication bus 610 may be communicatively isolated from communication bus 612, though the two communication buses 610, 612 may share a ground conductor. Each communication bus 610, 612 can extend along at least a portion of a length of the side rail 606, 608, respectively.

The patient support accessory 614 may include a connector 620 configured to electrically connect to the signal conductor 616 and ground conductor 618 of communication bus 610. Communication bus 610 may include a connector to which connector 620 connects. Alternatively, the signal conductor 616 and the ground conductor 618 may be exposed conductors such that contacts of the connector 620 can contact the signal conductor 616 and ground conductor 618 at any location. Multiple patient support accessories may be mounted to the side rails 606, 608. The controller 604 can communicate with patient support accessory 614 and any other patient support accessories connected to the side rails 606, 608 in similar fashion to the communication processes described above with respect to FIG. 4 and FIG. 5. The isolation of communication bus 610 from communication bus 612 enables the controller 604 to determine which side rails 606, 608 a given patient support accessory is attached.

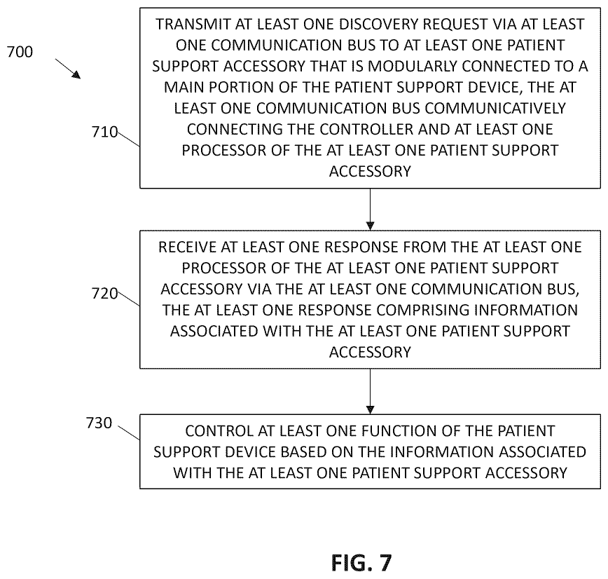

FIG. 7 illustrates an exemplary method 700 for controlling a patient support device based on a configuration of one or more patient support accessories attached to the patient support device. The method 700 can be used for any of the patient support devices described herein, such as patient support device 100 of FIGS. 1A-1B, patient support device 200 of FIG. 2, patient support device 400 of FIG. 4, patient support device 500 of FIG. 5, and/or patient support device 600 of FIG. 6. One or more steps of method 700 may be performed by a controller of a patient support device, such as controller 130 of FIG. 1A-1B, controller 204 of FIG. 2, controller 420 of FIG. 4, controller 520 of FIG. 5, and/or controller 604 of FIG. 6.

At step 710, the controller of the patient support device may transmit at least one information request via at least one communication bus to at least one patient support accessory that is modularly attached to a main portion of the patient support device. For example, with respect to FIG. 4, the controller 420 may transmit at least one information request via communication bus 422 to patient support accessories 404, 406, 408. The at least one information request may include a discovery request that requests identifiers associated with the processors of the patient support accessories 404, 406, 408 and at least one subsequent request for information associated with each patient support accessory that the controller may use to control at least one function of the patient support device.

At step 720, the controller may receive at least one response from the at least one processor of the at least one patient support accessory via the at least one communication bus. The at least one response can include information associated with the at least one patient support accessory. For example, with respect to FIG. 4, the controller 420 may receive at least one response to its information request from the processor of each of patient support accessory 404, patient support accessory 406, and patient support accessory 408.

The information received from a processor of a given patient support accessory may include identification information for the patient support accessory, such as a serial number or a model number. The information received from a processor of a given patient support accessory may include attributes of the patient support accessory, such as dimensional attributes like length, width, and height, and/or a weight capacity of the patient support accessory. For example, with reference to FIG. 4, the information received from the processor of patient support accessory 404 can include a serial number of patient support accessory 404 and/or a length, width, and/or height of the patient support accessory 404.

Step 720 may include the controller receiving responses from multiple patient support accessories, and the controller may determine an arrangement of the patient support accessories based on the response. For example, with reference to FIG. 5, controller 520 may determine the relative positions of the patient support accessories by receiving sequential responses from the patient support accessories according to their sequential location utilizing the enable conductors 514, 516, 518. Additionally, or alternatively, different patient support accessories may be communicatively connected to different communication buses, and the controller may determine the location of a patient support accessory based on which communication bus the response from the patient support accessory communicates is received on. For example, with reference to FIG. 2, controller 204 may determine that patient support accessory 208 is located on a first side of the main portion 202, and patient support accessory 240 is located on a second side of the main portion 202 based on the responses being received on different communication buses—communication bus 212 versus communication bus portion 236, respectively. Similarly, with reference to FIG. 6, controller 604 may determine that patient support accessory 614 is attached to the side of main portion 602 that includes side rail 606 based on receiving the response from patient support accessory 614 via communication bus 610.

At step 730, the controller may control at least one function of the patient support device based on the information associated with the at least one patient support accessory. Controlling at least one function of the patient support device based on the information associated with the at least one patient support accessory can include controlling articulation of the patient support device, such as by setting one or more limits of articulation of the patient support device such that the patient support accessory does not collide with nearby objects (e.g., the patient support device itself, the floor, and/or a nearby wall). The controller may determine one or more dimensions that account for any attached patient support accessories and may set a limit of articulation accordingly. For example, with reference to FIG. 1A, the controller 130 may add the length of patient support accessory 116 to the first end 112 of platform 110 and may take the added length into account to limit articulation of the platform and/or the first end 112 such that the patient support accessory 116 does not collide with a nearby object. With reference to the example situation illustrated FIG. 1B, the controller 130 may limit further downward movement of the platform 110 and may limit further tilting of the first end 112 such that the patient support accessory 116 does not collide with the floor 106. Controlling the at least one function of the patient support device according to step 730 may include articulating the patient support device in response to a user input. For example, with reference to FIG. 1A, a user may engage user input device 138 to articulate the patient support device 100 in a desired manner, such as pressing a “head end tilt down” button for tilting the first end 112 of the platform 110 of the patient support device 100 downward. The controller 130 may respond to such an input by tilting the first end 112 downward until a limit (determined by the controller 130 based on the information received from patient support accessory 116) is reached at which point the controller 130 may cease tilting the first end 112. In some examples, a user input device 138 may be engaged by a user for placing the patient support device in a predetermined configuration, and the controller 130 may control the patient support device to place the patient support device in the predetermined configuration within the limits determined based on the configurations of patient support accessory 118 and patient support accessory 116. For example, the configuration illustrated in FIG. 1B may be a predetermined configuration in which the first end 112 is tilted downward, the second end 114 is tilted downward, and the platform 110 is lowered. The extent to which the platform 110 is lowered, the first end 112 is tilted downward, and the second end 114 is tilted downward may be limited by the controller 130 according to the configurations of the patient support accessories 116, 118 such that the patient support accessories 116, 118 do not collide with the floor 106. Had patient support accessory 142 been attached at the first end 112 instead of patient support accessory 116, the controller 130 would not have lowered the platform 110 as much and/or would not have tilted the first end 112 as much.

Additionally, or alternatively, controlling at least one function of the patient support device can include displaying a notification to a user regarding a patient weight limit for the patient support device based on the weight capacity of the attached patient support accessory. For example, with reference to FIG. 4, a patient weight limit of each patient support accessory 404, 406, 408 may be included in the information received from the patient support accessories 404, 406, 408, and controller 420 may display the minimum patient weight limit of the patient weight limits received from the patient support accessories 404, 406, 408 on at least one display, which may include a display of the patient support device (e.g., display 140 of patient support device 100 of FIG. 1) or a remote display (e.g., display 228 of FIG. 2).

As noted above, the information received from a given patient support accessory may include at least one attribute of the patient support accessory (e.g., a dimension, a patient weight limit, a patient support accessory weight, etc.) that the controller may use to control at least one function of the patient support accessory. Alternatively, the controller may use identification information received from a patient support accessory to obtain the attribute(s) that the controller uses to control the at least one function of the patient support accessory. As such, method 700 may include the controller obtaining at least one attribute of at least one patient support accessory based on an identifier received from the patient support accessory. For example, with reference to FIG. 2, controller 204 may obtain a serial number from patient support accessory 208 and may use the serial number to query local database 218 or remote database 220 to obtain at least one attribute associated with the patient support accessory 208 that is stored therein.

Optionally, method 700 can include the controller continuously verifying the presence of at least one patient support accessory to determine whether a previously attached patient support accessory has been removed from the patient support device. If a patient support accessory that was previously attached is determined by the controller to have been removed, the controller may control one or more functions of the patient support device in accordance with the patient support accessory having been removed. For example, the controller may update one or more articulation limits such that the patient support device can be articulated to a greater amount than it could when the patient support accessory is attached. Alternatively, or additionally, where the patient support accessory had a lower patient weight limit than one or more other patient support accessories, the controller may update the display of a patient weight limit from displaying the patient weight limit of the removed patient support accessory to a patient weight limit of one or more still-attached patient support accessories. Similarly, the controller may continuously monitor for newly attached patient support accessories, such as by periodically transmitting a discovery request via one or more communication buses and may respond to the attachment of one or more newly attached patient support accessories by updating its control of one or more functions of the patient support device to account for the newly attached patient support accessory.

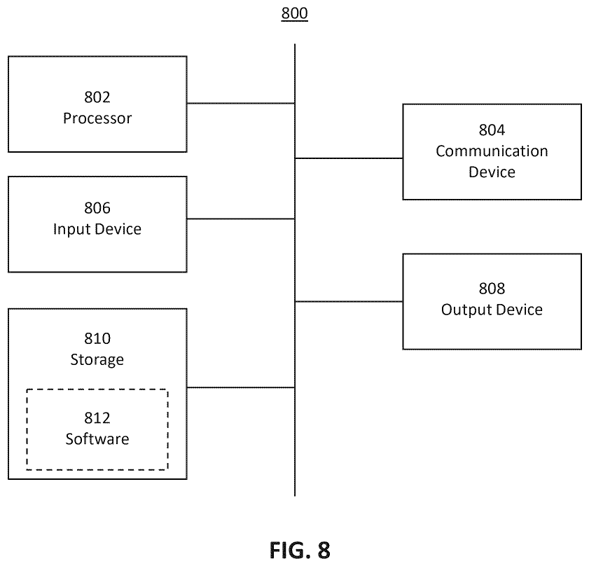

FIG. 8 depicts an exemplary computing device 800 that may be used for one or more computing components of any of the patient support devices described herein (e.g., patient support device 100, patient support device 200, patient support device 400, patient support device 500, and/or patient support device 600.) Computing device 800 may be used for performing various steps of the methods described herein, including one or more steps of method 700. Device 800 can be a host computer connected to a network. Device 800 can be a client computer or a server. Device 800 can be any suitable type of microprocessor-based device, such as a personal computer, workstation, server, or handheld computing device (i.e., a portable electronic device) such as a phone or tablet. The device can include, for example, one or more of processors 802, input device 806, output device 808, storage 810, and communication device 804. Input device 806 and output device 808 can generally correspond to those described above and can either be connectable or integrated with the computer.

Input device 806 can be any suitable device that provides directed input, such as a touch screen, keyboard or keypad, mouse, or voice-recognition device, in other words, input or directions provided or initiated by a user. Output device 808 can be any suitable device that provides output, such as a touch screen, haptics device, or speaker. Storage 810 can be any suitable device that provides storage, such as an electrical, magnetic, or optical memory, including a RAM, cache, hard drive, or removable storage disk. Communication device 804 can include any suitable device capable of transmitting and receiving signals over a network, such as a network interface chip or device. The components of the computer can be connected in any suitable manner, such as via a physical bus or wirelessly.

Software 812, which can be stored in storage 810 and executed by processor 802, can include, for example, the programming that embodies the functionality of the present disclosure (e.g., as embodied in the devices as described above). Software 812 can also be stored and/or transported within any non-transitory computer-readable storage medium for use by, or in connection with, an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 810, that can contain or store programming for use by, or in connection with, an instruction execution system, apparatus, or device. Software 812 can also be propagated within any transport medium for use by, or in connection with, an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by, or in connection with, an instruction execution system, apparatus, or device. The transport-readable medium can include, but is not limited to, an electronic, magnetic, optical, electromagnetic, or infrared wired or wireless propagation medium.

Device 800 may be connected to a network, which can be any suitable type of interconnected communication system. The network can implement any suitable communication protocols and can be secured by any suitable security protocols. The network can comprise network links of any suitable arrangement that can implement the transmission and reception of network signals, such as wireless network connections, T1 or T3 lines, cable networks, DSL, or telephone lines. Device 800 can implement any operating system suitable for operating on the network. Software 812 can be written in any suitable programming language, such as C, C++, Java, or Python. In various examples, application software embodying the functionality of the present disclosure can be deployed in different configurations, such as in a client/server arrangement or through a web browser as a web-based application or web service, for example.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

What is claimed is:

1. A method for controlling a patient support device, comprising:
transmitting, by a controller of the patient support device, at least one information request via at least one communication bus to at least one patient support accessory that is modularly attached to a main portion of the patient support device, the at least one communication bus communicatively connecting the controller and at least one processor of the at least one patient support accessory;
receiving, by the controller, at least one response from the at least one processor of the at least one patient support accessory via the at least one communication bus, the at least one response comprising information associated with the at least one patient support accessory; and
controlling at least one function of the patient support device based on the information associated with the at least one patient support accessory.

2. The method of claim 1, wherein the information associated with the at least one patient support accessory comprises information associated with a weight capacity of the at least one patient support accessory.

3. The method of claim 2, wherein controlling the at least one function comprises displaying, on at least one display, a notification associated with the weight capacity of the at least one patient support accessory.

4. The method of claim 3, wherein the at least one display comprises at least one display of the patient support device or at least one external display.

5. The method of claim 3, wherein the notification associated with the weight capacity comprises a patient weight limit.

6. The method of claim 1, wherein the information associated with the at least one patient support accessory comprises dimensional information associated with a size of the at least one patient support accessory.

7. The method of claim 6, wherein the patient support device is configured to articulate, and controlling the at least one function comprises limiting articulation of the patient support device based on the dimensional information associated with the size of the at least one patient support accessory.

8. The method of claim 1, wherein the information associated with the at least one patient support accessory comprises identification information, and wherein the method comprises querying a database with the identification information to obtain at least one attribute of the at least one patient support accessory, wherein controlling the at least one function of the patient support device based on the information associated with the at least one patient support accessory comprises controlling the at least one function of the patient support device based on the at least one attribute obtained from the database.

9. The method of claim 1, wherein receiving the at least one response from the at least one processor of the at least one patient support accessory comprises receiving responses from multiple patient support accessories, and wherein the method comprises determining an arrangement of the multiple patient support accessories based on the responses.

10. The method of claim 9, wherein a response from a first patient support accessory of the multiple patient support accessories is received via a first communication bus that is associated with a first side of the main portion of the patient support device and a response from a second patient support accessory of the multiple patient support accessories is received via a second communication bus that is associated with a second side of the main portion of the patient support device, and wherein determining the arrangement of the multiple patient support accessories comprises determining that the first patient support accessory is arranged at the first side of the main portion of the patient support device and the second patient support accessory is arranged at the second side of the main portion of the patient support device.

11. The method of claim 9, wherein a first patient support accessory of the multiple patient support accessories is mounted to a second patient support accessory of the multiple patient support accessories, and wherein determining the arrangement of the multiple patient support accessories comprises determining that the first patient support accessory is mounted to the second patient support accessory.

12. A patient support device comprising:
a main portion comprising a controller and a first communication bus portion; and
a patient support accessory modularly attached to the main portion and comprising at least one processor, memory storing information associated with the patient support accessory, and a second communication bus portion that is connected to the first communication bus portion thereby forming a communication bus between the at least one processor and the controller,
wherein the controller is configured to transmit at least one information request to the at least one processor of the patient support accessory via the communication bus to obtain the information associated with the patient support accessory and to control at least one function of the patient support device based on the information associated with the patient support accessory.

13. The patient support device of claim 12, wherein the first communication bus portion comprises a first connector, the second communication bus portion comprises a second connector, the patient support accessory comprises mounts that engage with corresponding mounts of the main portion and the second connector connects to the first connector when the mounts of the patient support accessory engage with the mounts of the main portion.

14. The patient support device of claim 12, wherein the first communication bus portion comprises a first connector that is connected to a connector of the patient support accessory and a second connector that is configured for connecting to a connector of an additional patient support accessory.

15. The patient support device of claim 12, wherein the main portion comprises a third communication bus portion for connecting to a communication bus portion of a second patient support accessory that is modularly attached to the main portion.

16. The patient support device of claim 12, wherein the communication bus between the at least one processor and the controller comprises a single data transmission conductor.

17. The patient support device of claim 12, wherein the patient support device is configured to articulate, and controlling the at least one function comprises limiting articulation of the patient support device based on dimensional information associated with a size of the patient support accessory.

18. The patient support device of claim 12, wherein the information associated with the patient support accessory comprises identification information, and the controller is configured to query a database with the identification information to obtain at least one attribute of the patient support accessory, wherein controlling the at least one function of the patient support device based on the information associated with the patient support accessory comprises controlling the at least one function of the patient support device based on the at least one attribute obtained from the database.

19. The patient support device of claim 12, wherein the patient support accessory is a first patient support accessory, and the patient support device comprises a second patient support accessory modularly attached to the main portion or to the first patient support accessory, and the controller is configured to determine an arrangement of the first and second patient support accessories based on the information obtained from the first patient support accessory and information obtained from the second patient support accessory.

20. A non-transitory computer readable storage medium comprising instructions for execution by one or more processors of a controller of a patient support device to cause the controller to:
transmit at least one information request via at least one communication bus to at least one patient support accessory that is modularly connected to a main portion of the patient support device, the at least one communication bus communicatively connecting the controller and at least one processor of the at least one patient support accessory;
receive at least one response from the at least one processor of the at least one patient support accessory via the at least one communication bus, the at least one response comprising information associated with the at least one patient support accessory; and
control at least one function of the patient support device based on the information associated with the at least one patient support accessory.
